(19) United States
(12) Patent Application Publication
(10) Pub. No.: US 2011/0160099 A1
(43) Pub. Date: Jun. 30, 2011

(54) INVERT EMULSION WELLBORE FLUIDS AND METHOD FOR REDUCING TOXICITY THEREOF

(75) Inventors: Arvind D. Patel, Sugar Land, TX (US); Maribella Irving, Houston, TX (US)

(73) Assignee: M-I L.L.C., Houston, TX (US)

(21) Appl. No.: 13/063,014

(22) PCT Filed: Sep. 11, 2008
(86) PCT No.: PCT/US08/75934

§ 371 Date: Mar. 9, 2011

(51) Int. Cl. C09K 8/26; C09K 8/60; C09K 8/50

(52) U.S. Cl. 507/130; 507/239; 507/244; 507/243; 507/269; 507/129; 507/131; 507/140

(57) ABSTRACT

A method for reducing the toxicity of an invert emulsion wellbore fluid is disclosed. The method comprises forming an invert emulsion wellbore fluid comprising an oleaginous continuous phase, an aqueous discontinuous phase, and an emulsifying fluid, wherein the emulsifying fluid comprises a nitrogen-containing emulsifying agent and an alkalinity agent, and wherein the invert emulsion wellbore fluid produces an LC50 (SSP) of at least 30,000 parts per million at 3000° F.

### FIELD OF INVENTION

The invention relates generally to wellbore fluids, and more specifically to low toxicity invert emulsion wellbore fluids.

### BACKGROUND OF INVENTION

When drilling or completing wells in earth formations, various fluids typically are used in the well for a variety of reasons. Common uses for well fluids include: lubrication and cooling of drill bit cutting surfaces while drilling generally or drilling-in (i.e., drilling in a targeted petroliferous formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, fluid used for emplacing a packer, abandoning the well or preparing the well for abandonment, and otherwise treating the well or the formation.

Drilling fluids or muds typically include a base fluid (water, diesel or mineral oil, or a synthetic compound), weighting agents (most frequently barium sulfate or barite is used), emulsifiers and emulsifier systems, fluid loss additives, viscosity regulators and the like, for stabilizing the system as a whole and for establishing the desired performance properties.

Oil-based drilling fluids are generally used in the form of invert emulsion muds. Invert emulsion fluids are employed in drilling processes for the development of oil or gas sources, as well as, in geothermal drilling, water drilling, geoscientific drilling, and mine drilling. Specifically, the invert emulsion fluids are conventionally utilized for such purposes as providing stability to the drilled hole, forming a thin filter cake, and lubricating the drilling bore and the downhole area and assembly.

An invert emulsion wellbore fluid consists of three phases: an oleaginous phase, an aqueous phase, and a finely divided particle phase. The discontinuous aqueous phase is dispersed in an external or continuous oleaginous phase with the aid of one or more emulsifiers. The oleaginous phase may be a mineral or synthetic oil, diesel or crude oil, while the aqueous phase is usually water, sea water, or brines such as calcium chloride or sodium chloride.

An invert emulsion is achieved through the use of emulsifiers, which reduce the surface tension between the discontinuous aqueous phase and the continuous oleaginous phase. Emulsifiers stabilize the mixture by being partially soluble in the both the aqueous and oleaginous phases. Generally, emulsifiers used in oil-based muds contain nitrogen, which may release ammonia vapor at elevated temperatures. Ammonia vapor can be toxic and noxious, and large quantities of ammonia vapor may render the work environment undesirable for an operator. Accordingly, there exists a need for providing invert emulsion fluids that are stable at high temperatures and do not release ammonia vapors.

### SUMMARY OF INVENTION

in one aspect, the present invention relates to a method of reducing the toxicity of a downhole operation comprising circulating an invert emulsion wellbore fluid in a wellbore, wherein the invert emulsion wellbore fluid comprises an oleaginous continuous phase, an aqueous discontinuous phase, a compound comprising at least one nitrogen atom, and an alkalinity agent, wherein the invert emulsion wellbore fluid has an LC50 (SPP) value of at least 30,000 parts per million at 300° F. in some aspects, and an LC50 (SPP) value of at least 500,000 parts per million at 350° F. in other aspects. The compound may be an emulsifying agent selected from the group consisting of amidoamines, polyamidoamines, polyamines, quaternaryamines, amides, polyamides immidazolines, oxazolines and combinations thereof. Alternatively, the emulsifying agent may be an amido amine derived from a fatty acid and a polyalkelene polyamine. The alkalinity agent may be magnesium oxide. The ratio between the compound comprising at least one nitrogen atom and the alkalinity agent may have a range of about 1:2 to about 2:1.

In another aspect, the present invention relates to a method of reducing the toxicity of an invert emulsion wellbore fluid comprising forming the invert emulsion wellbore fluid comprising an oleaginous continuous phase, an aqueous discontinuous phase, and an emulsifying fluid, wherein the invert emulsion wellbore fluid produces an LC50 (SPP) value of at least 30,000 parts per million at 300° F. The emulsifying fluid may comprise an alkalinity agent and a nitrogen-containing emulsifying agent. The nitrogen-containing emulsifying agent contains at least one nitrogen atom, and may be selected from the group consisting of amidoamines, polyamidoamines, polyamines, quaternaryamines, amides, polyamides, immidazolines, oxazolines and combinations thereof. The alkalinity agent may be magnesium oxide. The invert emulsion wellbore fluid may further have an LC50 (SPP) value of at least 500,000 parts per million at 350° F. The ratio between the emulsifying agent and the alkalinity agent may have a range of about 1:2 to about 2:1.

In another aspect, the present invention relates to an invert emulsion wellbore fluid comprising an oleaginous continuous phase, an aqueous discontinuous phase, a nitrogen-containing emulsifying agent, and magnesium oxide, Wherein the invert emulsion wellbore fluid has a LC50 (SSP) value of at least 30,000 parts per million at 300° F. the nitrogen-containing emulsifier may be selected from the group consisting of amidoamines, polyamidoamines, polyamines, quaternaryamines, amides, polyamides, immidazolines, oxazolines and combinations thereof. The ratio between the emulsifying agent and the alkalinity agent may have a range of about 1:2 to about 2:1.

Other aspects and advantages of the claimed subject matter will be apparent from the following description and the appended claims.

### DETAILED DESCRIPTION

In one aspect, embodiments disclosed herein relate to emulsifying fluids used in forming water-in-oil emulsions. In particular, embodiments disclosed herein relate to the use of emulsifying fluids for forming water-in-oil emulsions that do not produce toxic vapors in high temperature applications. Reduced toxicity emulsifying fluids may be comprised, of several components including an emulsifying agent and an alkalinity agent.

The term “water-in-oil emulsion” refers to emulsions where the continuous phase is an oleaginous fluid and the discontinuous phase is an aqueous fluid, wherein the discontinuous phase is dispersed within the continuous phase. “Water-in-oil emulsion” and “invert emulsion” will be used throughout, and should be interpreted to mean the same.

When combining the two immiscible fluids (aqueous and oleaginous) without the use of a stabilizing emulsifier, while it is possible to initially disperse or emulsify one fluid within the other, after a period of time, the discontinuous, dispersed fluid droplets coalesce or flocculate, for example, due to the instability of the formed emulsion. Thus, to stabilize the emulsion, an emulsifier may be used. Whether an emulsion turns into a water-in-oil emulsion or an oil-in-water emulsion depends on the volume fraction of both phases and on the type of emulsifier.

Water-in-oil emulsions are typically stabilized by steric stabilization (van der Waals repulsive forces). Formation of the water-in-oil emulsion may be on the surface, or may occur in situ upon injection of the emulsifying fluid downhole. If the emulsifying fluid is used to form an water-in-oil emulsion on the surface, conventional methods can be used to prepare the direct emulsion fluids in a manner analogous to those normally used to prepare emulsified drilling fluids. In particular, various agents may be added to either an oleaginous fluid or aqueous fluid, with the emulsifying fluids being included in either of the two fluids, but preferably the oleaginous phase, and then vigorously agitating, mixing, or shearing the oleaginous fluid and the aqueous fluid to form a stable water-in-oil emulsion. If the water-in-oil emulsion is formed on the surface, one skilled in the art would appreciate that the invert emulsion wellbore fluid may be pumped downhole for use in various operations, including for example, drilling, completion, displacement and/or wash fluid. Alternatively, it is also within the scope of the present disclosure that the emulsifying fluid may be pumped downhole for formation of an invert emulsion downhole. In yet other embodiments, the emulsifying fluid may be used to emulsify fluids returned to the surface.

Generally, the Bancroft rule applies to the behavior of emulsions: emulsifiers and emulsifying particles tend to promote dispersion of the phase in which they do not dissolve very well; for example, a compound that dissolves better in oil than in water tends to form water-in-oil emulsions (that is they promote the dispersion of water droplets throughout a continuous phase of oil). Emulsifiers are typically amphiphilic. That is, they possess both a hydrophilic portion and a hydrophobic portion. The chemistry and strength of the hydrophilic polar group compared with those of the lipophilic nonpolar group determine whether the emulsion forms as an oil-in-water or water-in-oil emulsion.

Reduced toxicity emulsifying fluids for forming stable invert emulsions generally comprise an emulsifying agent and an alkalinity agent in general, the invert emulsion may contain both water soluble and oil soluble emulsifying agents. One skilled in the art would appreciate that a number of emulsifying agents may, be used to generate an invert emulsion, including nonionic, cationic or anionic emulsifying agents, as long as a hydrophilic/lipophilic balance sufficient to obtain a stable emulsion of water into oil. In one aspect, to form an invert emulsion, the emulsifying agent has a HLB value of about 4 to about 9. In another aspect, the emulsifying agent has a HLB value of about 6 to about 9.

Emulsifying agents of the present invention are generally nitrogen-containing compounds. The term “nitrogen-containing compound” as used herein refers to compounds containing at least one nitrogen atom. Examples of nitrogen-containing emulsifying agents that may produce a water-in-oil emulsion include amido amines, polyamidoamines, polyamines, quaternaryamines, amides, polyamides, immidazolines, oxazolines and combinations thereof. In some aspects, the nitrogen containing emulsifying agent is amido-amine derived from fatty acid and polyalkelene polyamine.

When exposed to high temperatures for prolonged periods of time, nitrogen-containing compounds may release noxious vapors that may aggravate operators. The term “high temperature” as used herein refers to temperatures exceeding 300° F. In high temperature environments, those skilled in the art may substitute nitrogen-free emulsifying agents in place of nitrogen-containing emulsifying agents. However, these nitrogen-free emulsifying agents are often expensive, and may not provide as stable of emulsions as nitrogen-containing compounds are able to provide. Instead, the emulsifying fluids of the present invention provide a surprising combination of nitrogen-containing emulsifying agents with an alkalinity agent to reduce the toxicity of the invert emulsion wellbore fluid in high temperature environments. The term “alkalinity agent” as used herein refers to basic compounds that are capable of resisting a decrease in pH upon the addition of acid. Alkalinity agents of the present invention include magnesium oxide.

The ratio between the emulsifying agent and the alkalinity agent should be sufficient to inhibit the release of ammonia vapors upon exposure of the invert emulsion wellbore fluid to high temperatures. In one embodiment, the ratio of the emulsifying agent to the alkalinity agent is 1 to 2; in another embodiment, 1 to 1; and in yet another embodiment 2 to 1.

The oleaginous fluid that may form the continuous phase of the stabilized water-in-oil emulsion may be a liquid, more preferably a natural or synthetic oil, and more preferably the oleaginous fluid is selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids; similar compounds known to one of skill in the art; and mixtures thereof. The concentration of the oleaginous fluid should be sufficient that an invert emulsion forms and may be more than about 40% by volume of the emulsion in one embodiment and more than 60% by volume in yet another embodiment.

Aqueous fluids that may form the discontinuous phase of the stabilized water-in-oil emulsion may include at least one of water, sea water, brine, mixtures of water and water-soluble organic compounds and mixtures thereof. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, sulfur, aluminum, magnesium, potassium, strontium, silicon, lithium, and phosphorus salts of chlorides, bromides, carbonates, iodides, chlorates, bromates, formates, nitrates, oxides, and fluorides. Salts that may be incorporated in a brine include any one or more of those present in natural seawater or any other organic or inorganic dissolved salts. Additionally, brines that may be used in the drilling fluids disclosed herein may be natural or synthetic, with synthetic brines tending to be much simpler in constitution.

While emulsifying fluids for reducing the toxicity of an invert emulsion wellbore fluid have been discussed herein, one of ordinary skill in the art may appreciate that the alkalinity agent may be combined with any nitrogen-containing compound that is incorporated into a wellbore fluid as an additive. The key to reducing the toxicity of the resulting wellbore fluid at high temperatures is the combination of the nitrogen-containing compound with the alkalinity agent in a ratio sufficient for reducing the toxicity at high temperatures. Examples of nitrogen-containing compounds currently used in wellbore fluids include additives such as supplemental surfactants, viscosifying agents, and the like.

Various supplemental surfactants and wetting agents conventionally used in invert emulsion fluids may optionally be incorporated in the fluids of this invention. Such surfactants are, for example, fatty acids, soaps of fatty acids, amido amines, polyamides, poly/amines, oleate esters, imidazoline derivatives, oxidized crude tall oil, organic phosphate esters, alkyl aromatic sulfates and sulfonates, as well as, mixtures of the above. Generally, such surfactants are employed in an amount which does not interfere with the fluids of this invention being used as drilling fluids.

Viscosifying agents, for example, organophillic clays, may optionally be employed in the invert drilling fluid compositions of the present invention. Usually, other viscosifying agents, such as oil soluble polymers, polyamide resins, polycarboxylic acids and fatty acid soaps may also be employed. The amount of viscosifying agent used in the composition will necessarily vary depending upon the end use of the composition. Usually such viscosifying agents are employed in an amount Which is at least about 0.1, preferably at least about 2, more preferably at least about 5 percent by weight to volume of the total fluid. VG-69™ and VG-PLUS™ are organoclay materials and Versa HRP™ is a polyamide resin material manufactured and distributed by M-I L.L.C. which are suitable viscosifying agents.

The invert emulsion drilling fluids of this invention may optionally contain a weight material. The quantity and nature of the weight material depends upon the desired density and viscosity of the final composition. The preferred weight materials include, but are not limited to, barite, calcite, mullite, gallena, manganese oxides, iron oxides, mixtures of these and the like. The weight material is typically added in order to obtain a drilling fluid density of less than about 24, preferably less than about 21, and most preferably less than about 19.5 pounds per gallon.

Fluid loss control agents such as modified lignite, polymers, oxidized asphalt and gilsonite may also be added to the invert drilling fluids of this invention. Usually such fluid loss control agents are employed in an amount which is at least about 0.1, preferably at least about 1, more preferably at least about 5 percent by weight to volume of the total fluid.

Advantageously, embodiments of the present disclosure for at least one of the following. The emulsifying fluids of the present disclosure allows for the formation of a stable invert water-in-oil emulsion, that may be formed on before, during, or after downhole operations, depending on the needs of the operator. Further, the emulsifier of the present disclosure allows for the formation of a stable invert emulsion that renders reduced toxicity upon exposure to high temperature conditions.

### EXAMPLES

Two sample fluids containing the components shown in Table 1 below were prepared. An internal olefin C16-18 base oil (20 ml); was blended with water, VG-PLUS™, SUREWET®, SUREMUL®. Silwet L-7622, calcium chloride, RHETHIK®, barite, and rev dust to create an invert emulsion fluid in accordance with the present invention. In Formulation L magnesium oxide was the alkalinity agent. In formulation 2, lime was the alkalinity agent. VG-PLUS™ is an organophillic clay lubricant for oil-based systems; SUREWET® is a wetting agent and emulsifier for oil-based systems; SUREMUL® is an emulsifier for use in oil-based systems; RHETHIK® is a viscosifier and rheology modifier, all of which are available from M-I LLC (Houston, Tex.). Silwet® L-7622 is a organosilicone surface tension reducing agent and defoamer available from Momentive Performance Materials.

TABLE 1

| Product | Units | Forulation-1 | Formulation-2 |
|---|---|---|---|
| IO-16-18 | grams | 150.9 | 150.9 |
| VG-PLUS ™ | grams | 6.0 | 6.0 |
| Lime | grams | 0.0 | 8.0 |
| Magnesium | grams | 8.0 | 0.0 |
| Oxide | | | |
| SUREWET ® | grams | 6.0 | 6.0 |
| SUREMUL ® | grams | 10 | 10 |
| Silwet ® L- | grams | 2.0 | 2.0 |
| 7622 | | | |
| Calcium | grams | 22.6 | 22.6 |
| Chloride | | | |
| Water | grams | 63.3 | 63.3 |
| RHETHIK ® | grams | 1.0 | 1.0 |
| Barite | grams | 212 | 212 |
| Rev Dust | grams | 20.0 | 20.0 |

The fluids were heat-aged at the temperatures and time intervals indicated in Table 2, with the rheologies indicating stable invert emulsions below:

TABLE 2
Rheology after Heat Aging - SUREMUL/SUREWET

| Temp. | Hrs | | 600 | 300 | 200 | 100 | 6 | 3 | 10″ | 10′ | PV | YP | HTHP |
|---|---|---|---|---|---|---|---|---|---|---|---|---|---|
| 150 | 16 | MagOx | — | — | — | — | — | — | — | — | — | — | — |
| 350 | 16 | | — | — | — | — | — | — | — | — | — | — | — |
| 350 | 64 | | 125 | 82 | 65 | 45 | 17 | 15 | 16 | 21 | 43 | 39 | 14 |
| 150 | 16 | Lime | 110 | 67 | 51 | 33 | 10 | 9 | 10 | 18 | 43 | 24 | 4 |
| 350 | 16 | | 92 | 59 | 44 | 28 | 7 | 6 | 6 | 10 | 33 | 26 | 10 |
| 10 | 64 | | 79 | 48 | 35 | 20 | 4 | 3 | 4 | 7 | 31 | 17 | 10 |

To demonstrate the toxicity performance of the drilling fluids formulated in accordance with the teachings of this invention, the Lethal Concentration (LC) value is determined for the samples. The LC value is the concentration of a chemical in water. Generally, the LC is expressed as LC50, which is the concentration of the chemical in water that results in killing 50% of the test subjects in the water. In some embodiments, the emulsifying agent of the present invention result in LC50 (suspended particulate phase (SPP)) values greater than 30,000 parts per million; in other embodiments, LC50 (SPP) values greater than 100,000 parts per million; and in yet other embodiments, LC50 (SPP) values greater than 500,000 parts per million.

TABLE 3
Results from Environmental Testing - LC50

| | | Temp | Time | LC50 Results |
|---|---|---|---|---|
| Emulsifier | Alkalinity agent | (° F.) | (hrs) | (ppm SPP) |
| Suremul/Surewet | Magnesium Oxide | 150 | 16 | >500,000 |
| Suremul/Surewet | Magnesium Oxide | 350 | 16 | >500,000 |
| Suremul/Surewet | Magnesium Oxide | 350 | 64 | >500,000 |
| Suremul/Surewet | Lime | 150 | 16 | =382,992 |
| Suremul/Surewet | Lime | 350 | 16 | 42,797 |
| Suremul/Surewet | Lime | 350 | 64 | <10,000 |

The results from the LC50 testing indicates that combination of the nitrogen-containing emulsifiers with magnesium oxide provide LC50 results exceeding 500,000 parts per million at 350° F.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of reducing the toxicity of a downhole operation comprising:
circulating the invert emulsion wellbore fluid in a wellbore, wherein the oil-based wellbore fluid comprises an oleaginous continuous phase, an aqueous discontinous phase, a compound comprising at least one nitrogen atom, and an alkalinity agent, wherein the oil-based wellbore fluid has an LC50 (SPP) value of at least 30,000 parts per million upon heat aging at 300° F.

2. The method of claim 1, wherein the compound comprising at least one nitrogen atom is a nitrogen-containing emulsifying agent.

3. The method of claim 2, wherein the nitrogen containing emulsifying agent is amido-amine derived from fatty acid and polyalkelene polyamine.

4. The method of claim 2, wherein the nitrogen-containing emulsifying agent is selected from the group consisting of amidoamines, polyamidoamines, polyamines, quaternary amines, amides, polyamides, immidazolines, oxazolines and combinations thereof.

5. The method of claim 1 wherein the alkalinity agent is magnesium oxide.

6. The method of claim 1, wherein the nitrogen-containing wellbore fluid has an LC50 (SPP) value of at least 500,000 parts per million after circulating the wellbore fluid in the wellbore at 350° F.

7. The method of claim 1, wherein the ratio of the compound comprising at least one nitrogen atom to the alkalinity agent is in the range of about 1:2 to about 2:1.

8. A method for reducing the toxicity of an invert emulsion wellbore fluid comprising:
forming the invert emulsion wellbore fluid comprising an oleaginous continuous phase, an aqueous discontinuous phase, and an emulsifying fluid, wherein the invert emulsion wellbore fluid produces a LC50(SPP) value of at least 30,000 parts per million upon heat aging at 300° F.

9. The method of claim 7, wherein the emulsifying fluid comprises an alkalinity agent and a nitrogen-containing emulsifying agent.

10. The method of claim 9, wherein the alkalinity agent is magnesium oxide.

11. The method of claim 9, Wherein the nitrogen-containing emulsifying agent has at least one nitrogen atom.

12. The method of claim 9, wherein the ratio of the nitrogen-containing emulsifying agent to the alkalinity agent is in the range of about 1:2 to about 2:1.

13. The method of claim 9, wherein the nitrogen-containing emulsifying agent is selecting from the group consisting of wherein the nitrogen-containing emulsifying agent is selected from the group consisting of amidoamines, polyamidoamines, quaternaryamines, amides, polyamides, immidazolines, oxazolines and combinations thereof.

14. The method of claim 8, wherein the invert emulsion wellbore fluid has a LC50 (SSP) of at least 500,000 parts per million at 350° F.

15. An invert emulsion wellbore fluid comprising:
an oleaginous continuous phase;
an aqueous discontinuous phase;
a nitrogen-containing emulsifier; and
magnesium oxide;
wherein the invert emulsion wellbore fluid has a LC50 (SSP) of at least 30,000 parts per million at 300° F.

16. The invert emulsion wellbore fluid of claim 15, wherein the nitrogen containing emulsifier is selected from the group consisting of amidoamines, polyamidoamines, quaternaryamines, amides, polyamides, immidazolines, oxazolines and combinations thereof.

17. The invert emulsion wellbore fluid of claim 15 further comprising a viscosifying agent.

18. The invert emulsion wellbore fluid of claim 15 further comprising a weighting agent.

19. The invert emulsion wellbore fluid of claim 15, wherein the ratio of nitrogen-containing emulsifier to magnesium oxide is in the range of about 1:2 to about 2:1.
